(19) United States
(12) Patent Application Publication
(10) Pub. No.: US 2004/0222191 A1
(43) Pub. Date: Nov. 11, 2004

(54) Method and apparatus for wet etching using hot etchant

(76) Inventors: Tai-Gyun Kim, Yongin-Si (KR); Jong-Kook Song, Suwon-Si (KR); Ki-Hwan Park, Kyunggi-Do (KR); Pyoung-Ho Lim, Osan-Si (KR)

Correspondence Address: HARNESS, DICKEY & PIERCE, P.L.C., P.O. BOX 8910, RESTON, VA, 20195, US

(21) Appl. No.: 10/840,269

(22) Filed: May 7, 2004

(30) Foreign Application Priority Data
May 7, 2003 (KR) 10-2003-28874

(51) Int. Cl. B44C 1/22

(52) U.S. Cl. 216/83

(57) ABSTRACT

Provided are exemplary methods and equipment for wet etching processes that utilize etchant solutions at elevated temperatures, particularly for wet etch processes incorporated in the production of semiconductor devices. According to the exemplary methods, the semiconductor wafers to be etched are preheated using one or more of a variety of methods and apparatus prior to immersion in the hot etchant solution. This preheating of the semiconductor wafers reduces or eliminates temperature variation in etchant solution resulting from the insertion of the semiconductor wafers thereby improving the consistency and repeatability of the etch process.

### CROSS REFERENCE TO RELATED APPLICATION

This application claims priority under 35 U.S.C. § 119 from Korean Patent Application No. 2003-28874, filed on May 7, 2003, in the Korean Intellectual Property Office, the disclosure of which is hereby incorporated by reference in its entirety.

### BACKGROUND OF THE INVENTION

1. Field of the Invention

The present invention relates to an improved method and apparatus for wet etching materials, more particularly the wet etching of material layers such silicon oxides, nominally SiO₂, and silicon nitrides, nominally Si₃N₄, during semiconductor manufacturing processes, and even more particularly, the wet etching of silicon nitride layers during semiconductor manufacturing processes.

2. Description of the Related Art

Generally, during the fabrication of semiconductor devices, a series of wet and dry etching processes are used to remove at least portions of previously formed material layers from the surface of semiconductor wafers. Dry etching processes typically use a mixture of activated gases to form a plasma for etching a wide variety of insulator, semiconductor and conductor materials. Although the use of dry etch processes has increased as the critical dimensions of the semiconductor devices has decreased and the need for anisotropic etching has increased, wet etching processes employing a range of liquid etchants are still commonly used for removing silicon oxides and silicon nitrides.

When silicon oxide is being removed, the etchant solution used is typically an aqueous solution of hydrofluoric acid, HF, and may include one or more buffering compounds to form a buffered HF solution (typically identified as BHF). Conversely, when silicon nitride is being removed, the liquid etchant typically includes an aqueous solution of phosphoric acid (H₃PO₄) at temperature in excess of 100° C., and more typically, a temperature in excess of 150° C.

As with all etch processes, it is preferred that a wet etch process be relatively consistent and repeatable while avoiding the consumption of excessive amounts of etchant. In many instances, wet etches are operated as batch processes in which a predetermined number of wafers may be processed through a given volume of etchant solution or a predetermined time period will pass before the etchant is refreshed or changed. As a result of these practices, various complications can arise including accumulation of etch byproducts in the etchant solution and variations in the etch rate. Variations in the etch rate increase the risk of underetching the target material if the etch duration is not increased sufficiently or overetching the target material if the etch rate is actually faster than anticipated, thus increasing the need for monitoring and adjustment of the etch processes.

With respect to wet etch processes for removing silicon nitrides, the effective etch rate is affected by the temperature of the etchant solution during the etch and the concentration of the etchant solution. The temperature of the etchant solution tends to vary over the course of the etch process, with the temperature being reduced initially upon the insertion of the process wafers and their carrier(s) and then recovering over the course of the etch as bath heaters are activated to compensate for the initial reduction in temperature. Various methods and apparatus designs have been proposed for addressing these factors including, for example, Yokomizo et al.'s U.S. Pat. No. 6,399,517 B2 and Shin et al.'s U.S. Pat. No. 5,843,850, both of which are incorporated herein, in their entirety, by reference.

The steps in a conventional wet etch process are illustrated in FIG. 1A with a corresponding conventional wet etch apparatus being illustrated in FIG. 1B. As illustrated in FIG. 1A, a conventional wet etch process includes the steps of rinsing a group of wafers and their associated carrier in a de-ionized (D.I.) water bath, S10, moving the rinsed wafers into an etch bath and immersing them in an etchant solution, S20, upon completion of the etch, moving the wafers to a rinse tank S30 to remove residual etchant solution and then drying the wafers S40 in preparation for the next process step.

Although the particular equipment utilized in the conventional process may vary in complexity and layout, a basic apparatus that may be utilized for performing the conventional process may include, as illustrated in FIG. 1B, a wet station 50 including a first rinse bath 10, an etch bath 20 and a rinse bath 30. As will be appreciated, additional elements such as other rinse and/or etch baths, control valves, heaters, coolers, mixers, reservoirs, timers and wafer transport mechanisms may be incorporated into a wet station as needed depending on the particular process being practiced. A drying unit may also be incorporated into a wet station, but, as illustrated in FIG. 1B, is more conventionally provided as a separate workstation that may be connected to the wet station through an automated wafer transport mechanism.

Referring to the apparatus illustrated in FIG. 1B, in a conventional silicon nitride etch process, the etch bath 20 will include an aqueous solution of phosphoric acid at a temperature of between about 150° C. and 180° C., with the temperature being maintained by heaters and an associated temperature controller. The rinse baths 10, 30 are typically connected to the main D.I. water supply for the fabrication area and will operated with water at or about room temperature, approximately 25° C.

When the wafers and associated wafer carrier are moved from the initial rinse bath 10 into the etch bath 20, the temperature of the etchant solution will be reduced. The magnitude of the temperature reduction will depend on the relative thermal masses of the volume of etchant and the thermal mass of the wafers and their associated carrier. When the temperature controller detects the temperature departing from the desired etch temperature, heating elements will be activated, or their activity increased, in order to return the etch bath to the desired etch temperature. The effective etch rate will vary depending on the magnitude and duration of the departure(s) of the etchant solution from the target etch temperature, introducing undesirable variation in the wet etch process.

The steps in a conventional wet silicon nitride etch process are illustrated in FIG. 2A with a corresponding conventional wet etch apparatus being illustrated in FIG. 2B. As illustrated in FIG. 2A, a conventional wet etch process includes the steps of etching a group of wafers to remove residual and native oxides S100, rinsing the wafers to remove residual oxide etchant in a de-ionized (D.I.) water bath, S110, moving the rinsed wafers into an etch bath and immersing them in an etchant solution, S120, upon completion of the etch, moving the wafers to a rinse tank S130 to remove residual etchant solution and then drying the wafers S140 in preparation for the next process step.

Although the particular equipment utilized in the conventional process may vary in complexity and layout, a basic apparatus that may be utilized for performing the conventional process may include, as illustrated in FIG. 2B, a wet station 100 including a first etch bath 100, a first rinse bath 110, an etch bath 120 and a rinse bath 130. As will be appreciated, additional elements such as other rinse and/or etch baths, control valves, heaters, coolers, mixers, reservoirs, timers and wafer transport mechanisms may be incorporated into a wet station as needed depending on the particular process being practiced. A drying unit 140 may also be incorporated into a wet station, but, as illustrated in FIG. 2B, is more conventionally provided as a separate workstation that may be connected to the wet station through an automated wafer transport mechanism.

Referring to the apparatus illustrated in FIG. 2B, in a conventional silicon nitride etch process, the etch bath 100 will include an aqueous solution of buffered HF at a temperature typically less than 30° C., and a second hot etch bath 120 containing an aqueous solution of phosphoric acid at a temperature of between about 150° C. and 180° C., with the temperature of the hot etch bath being maintained by heaters and an associated temperature controller. The rinse baths 110, 130 are typically connected to the main D.I. water supply for the fabrication area and will operated using water at or about room temperature, approximately 25° C.

When the wafers and associated wafer carrier are moved from the initial rinse bath 10 into the etch bath 20, the temperature of the etchant solution will be reduced. The magnitude of the temperature reduction will depend on the relative thermal masses of the volume of etchant and the thermal mass of the wafers and their associated carrier. When the temperature controller detects the temperature departing from the desired etch temperature, heating elements will be activated, or their activity increased, in order to return the etch bath to the desired etch temperature. The effective etch rate will vary depending on the magnitude and duration of the departure(s) of the etchant solution from the target etch temperature, introducing undesirable variation in the wet etch process.

### BRIEF SUMMARY OF THE INVENTION

Embodiments of the present invention provide a method of processing semiconductor wafers in a hot process solution including preheating the semiconductor wafers having an initial wafer temperature Tᵢ to produce preheated semiconductor wafers having a preheat temperature Tₕ, immersing the preheated semiconductor wafers in the hot process solution, the hot process solution being maintained at a target process temperature Tₚ, the preheat temperature Tₕ being sufficiently close to the target process temperature Tₚ to prevent significant departure of the temperature of the hot process solution from the target process temperature Tₚ.

Embodiments of the present invention may be utilized for wafers having an initial wafer temperature Tᵢ of about 20 to about 30° C., preheating the wafers to a preheat temperature of from about 70 to 180° C. prior to immersing the wafers in a hot process solution maintained at a target process temperature Tₚ of from about 150to 180° C.

Embodiments of the invention may achieve the wafer heating using one or more of a variety of methods including exposing the semiconductor wafers to a heated liquid, exposing the semiconductor wafers to a heated gas, exposing the semiconductor wafers to infrared radiation and exposing the semiconductor wafers to microwave radiation. Exposing the semiconductor wafers to a heated liquid may include one of more methods including immersing the semiconductor wafers in heated water bath and spraying the semiconductor wafers with heated water.

Exposing the semiconductor wafers to a heated gas may include one of more methods including exposing the semiconductor wafers to heated N₂ gas, exposing the semiconductor wafers to heated air and exposing the semiconductor wafers to steam. Depending on the relative thermal masses of the preheated wafers, and their associated carrier, and the etchant solution, and the heating capacity available, the departure of the hot process solution from the target process temperature may be limited to less than about 3° C. and a duration of less than about 5 minutes.

Additional embodiments of the invention may incorporate other process solutions and other rinsing steps at a temperature of about Tᵢ before preheating the semiconductor wafers. In particular, a first process solution of buffered HF may be used to remove residual or native oxides at a temperature of no more than about 30° C., after which the wafers are preheated before immersion in a hot process solution of phosphoric acid having a target process temperature Tₚ of from about 158° C. to about 168° C.

Other embodiments of the invention provide methods for removing a silicon nitride layer from a semiconductor wafer including preheating the semiconductor wafer to a preheat temperature Tₕ of at least 70° C. to produce a preheated semiconductor wafer, immersing the preheated semiconductor wafer in a phosphoric acid solution maintained at a nominal process temperature Tₚ of at least 150° C. for an etch period sufficient to remove the silicon nitride layer and produce an etched semiconductor wafer, removing the etched semiconductor wafer from the phosphoric acid solution, and rinsing the etched semiconductor wafer with water to remove substantially all of the phosphoric acid solution.

Embodiments of the invention may include rinsing and preheating the semiconductor wafer in a single vessel that is arranged and configured for the selective and independent introduction of both cool water and hot water. The cool water may have a temperature of less than about 30° C. and the hot water may have a temperature of at least about 70° C. and less than about 95° C. The preheating may also be accomplishing using one or more hot gases having a temperature of at least about 100° C. such as heated N₂, heated air and steam. Additional heating methods such as microwave or infrared radiation may also be used separately or in conjunction with one or more other heating methods to increase and/or maintain the temperature of the preheated wafer prior to immersion in the hot process solution.

Regardless of the particular method or methods utilized to produce the preheated wafer, the preheated wafer will typically have a temperature Tₕ of at least about 70° C. and as high as about 200° C. The preheated wafers may have a preheat temperature Tₕ of no more than about 50° C. less, and may, in some instances, have a preheat temperature of no more than about 20° C. less, than the nominal process temperature of the hot process solution into which the wafers are to be immersed.

Embodiments of apparatus suitable for practicing the exemplary methods of the invention will include means for preheating the semiconductor wafers having an initial wafer temperature Tᵢ to produce preheated semiconductor wafers having a preheat temperature Tₕ and means for immersing the preheated semiconductor wafers in the hot process solution, the hot process solution being maintained at a target process temperature Tₚ, wherein the preheat temperature Tₕ is sufficiently close to the target process temperature Tₚ to limit the departure of the temperature of the hot process solution from the target process temperature Tₚ to no more than about 3° C. and a duration of no more than about 5 minutes.

The means for preheating the semiconductor wafers in a hot process solution may include one or more assembly selected from a device arranged and configured to hold the semiconductor wafers in a vessel and to provide the selective introduction of a heated liquid into the vessel, a device arranged and configured to hold the semiconductor wafers in a vessel and to provide the selective introduction of a heated gas stream into the vessel, a device arranged and configured to hold the semiconductor wafers in a vessel and to provide the selective introduction of infrared radiation into the vessel, and a device arranged and configured to hold the semiconductor wafers in a vessel and to provide the selective introduction of microwave radiation into the vessel.

Exemplary apparatus for practicing the exemplary embodiments of the invention may include a rinse/preheat tank configured to hold the semiconductor wafers, hot water supply connected to the rinse tank and a hot water supply valve selectively operable to control the introduction of hot water into the rinse tank. The rinse tank may be configured as a quick dump rinser (QDR) and the hot water supply may be configured to deliver deionized water to the rinse tank at a water temperature of at least about 70° C.

Exemplary apparatus for practicing the exemplary embodiments of the disclosed methods of the invention may include a preheating vessel arranged to hold the semiconductor wafers, a hot gas supply connected to the preheating vessel and a hot gas supply valve selectively operable to control the introduction of hot gas into the preheating vessel. Similarly, exemplary apparatus for practicing the exemplary embodiments of the disclosed methods may include devices arranged and configured to hold semiconductor wafers and expose the wafers to microwave or infrared radiation of sufficient duration and intensity so as to increase the temperature of the semiconductor wafers to a preheat temperature Tₕ according to the particular method being practiced.

### BRIEF DESCRIPTION OF THE DRAWINGS

Exemplary embodiments of the devices and methods that may be utilized to practice the present invention are addressed more fully below with reference to the attached drawings in which:

FIGS. 1A and 1B illustrate a conventional wet etch process and wet etch apparatus;

FIGS. 2A and 2B illustrate a conventional wet silicon nitride etch process and wet etch apparatus;

FIGS. 3A and 3B illustrate an exemplary wet silicon nitride etch process and wet etch apparatus according to the invention;

FIGS. 4-6 illustrate additional exemplary preheat unit configurations that may be utilized in etch apparatus according to the invention; and

FIG. 7 illustrates the improvement in temperature control of a hot process solution utilizing an exemplary method and apparatus according to the invention when compared with a conventional method and apparatus.

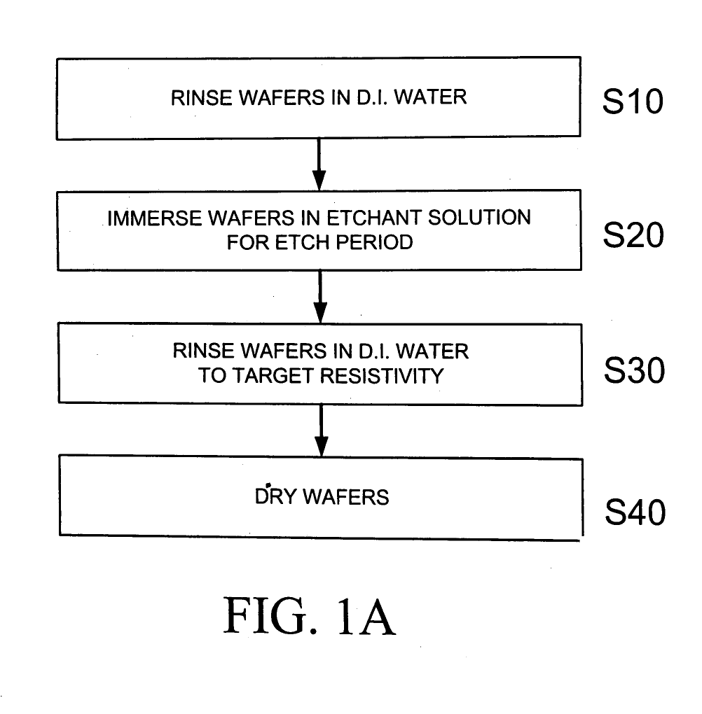

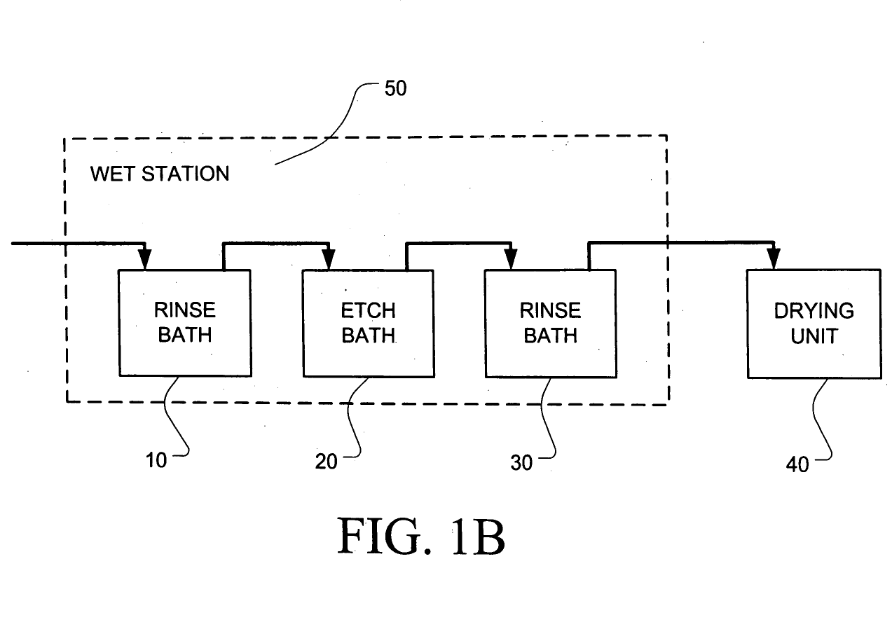

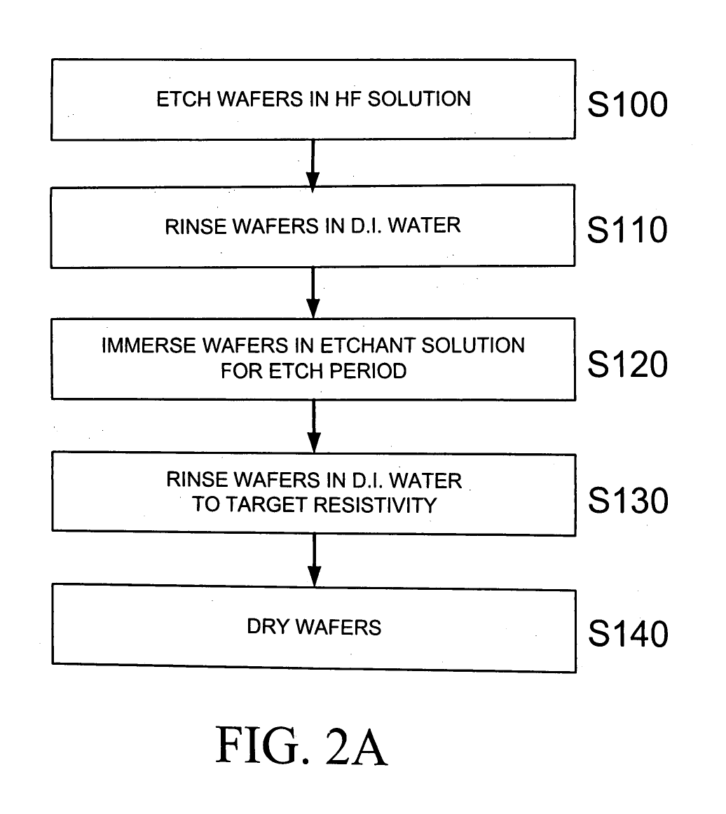

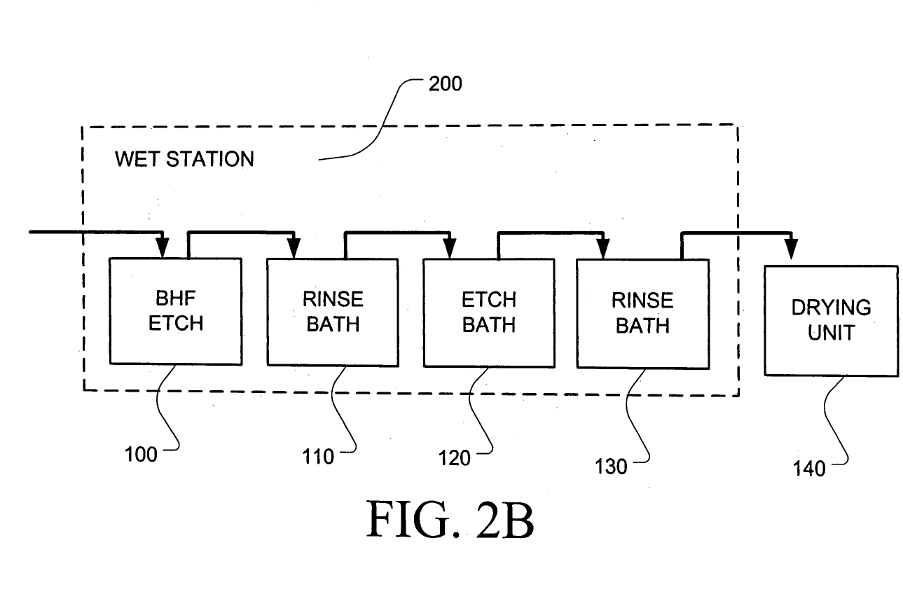

### DETAILED DESCRIPTION OF THE INVENTION

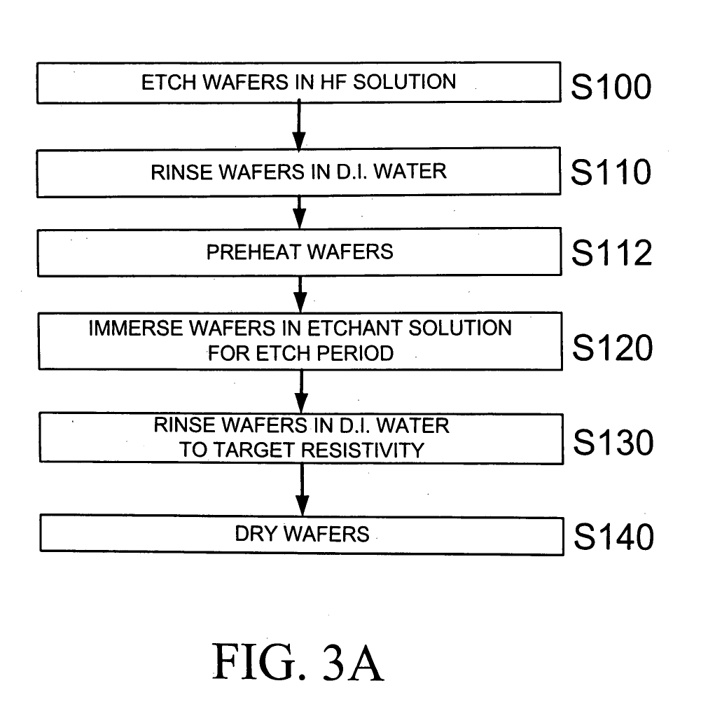

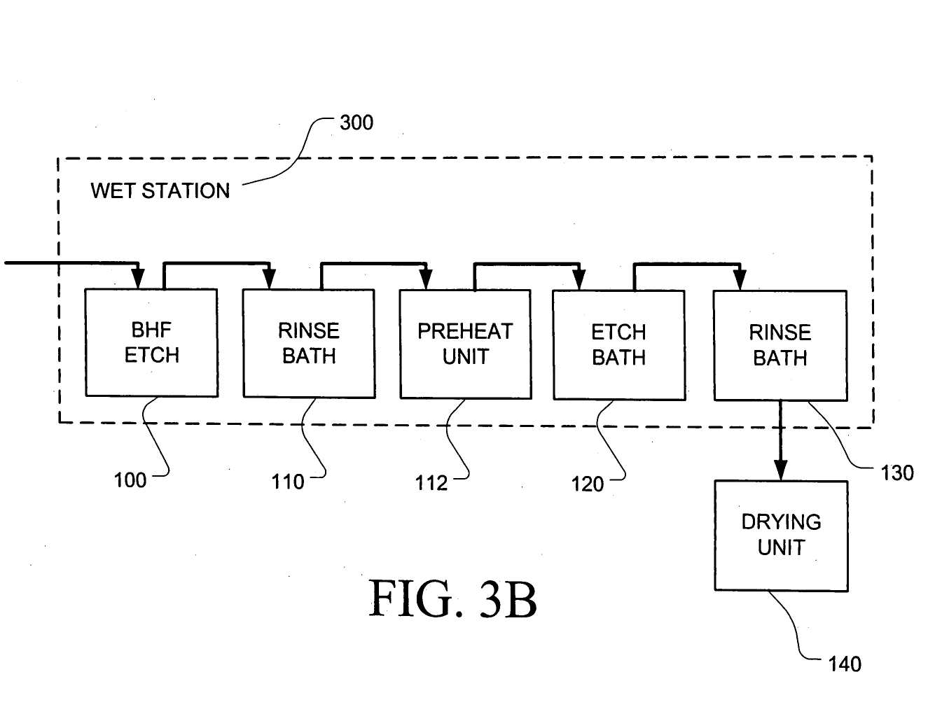

As illustrated in FIG. 3A, exemplary embodiments of the present method incorporate a preheating step to produce a preheated semiconductor wafer that is only then immersed in a hot process solution. In an exemplary silicon nitride etch process according to the invention, the semiconductor wafers are first etched (or deglazed) in a buffered HF solution S100 to remove residual and native oxides and then rinsed in D.I. water S110 to remove substantially all of the residual HF solution and produce clean semiconductor wafers.

The clean wafers have an initial temperature Tᵢ that will be approximately the same as the rinse water temperature, typically less than 30° C. The clean semiconductor wafers are then moved into a preheat unit, which may take a number of configurations, and preheated to produce preheated wafers having a temperature Tₕ.

Depending on the configuration of the apparatus, and the throughput of the apparatus utilized, the wafers may be held at the rinse step or the preheat step if the etch step will not be immediately available. The preheated wafers are then etched S120 in a hot etchant solution for a time sufficient to remove the target material layer from the wafer surface. The etched semiconductor wafers are then typically rinsed to remove substantially all of the residual etchant solution S130 and dried S140 to prepare them for subsequent processing.

As illustrated in FIG. 3B, an exemplary embodiment of an apparatus suitable for practicing the method illustrated in FIG. 3A may include a wet station 300 and a drying unit 140. Within wet station 300 may be arranged a BHF tank 100 for removing residual and native oxides from the wafers, a rinse bath 110, a preheat unit 112, an elevated temperature etch bath 120 and a second rinse bath 130.

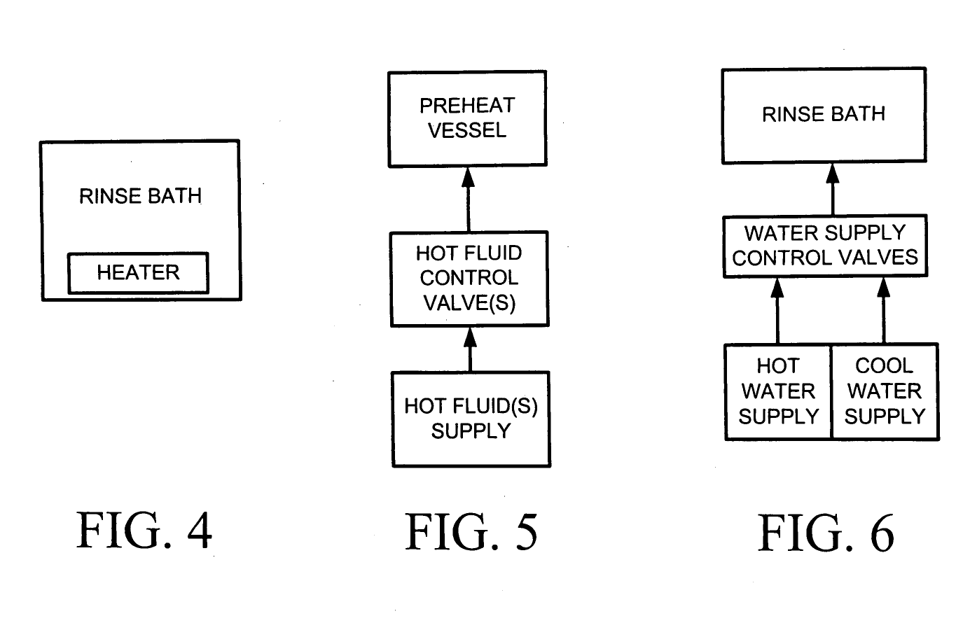

As indicated above, the preheat unit 112 may be incorporated in a variety of configurations. A first exemplary embodiment is illustrated in FIG. 4, in which a heater unit is incorporated in a rinse tank for increasing the temperature of the typical rinse water supply, generally less than about 30° C., to a temperature suitable for a preheat operation, typically at least 70° C.

Depending on the temperature of the etchant solution in etch bath 120, it may not be possible to achieve a satisfactory degree of preheating using a heated water bath. An exemplary embodiment of a preheat unit for achieving higher preheat temperatures is illustrated in FIG. 5. As shown, the semiconductor wafers are placed in a preheat vessel, container or other enclosure and therein exposed to a hot fluid such as water provided at a temperature above 70° C., steam, heated N₂ or heated air.

Although not illustrated, non-contact means may also be used to preheat the semiconductor wafers including, for example, microwave, visible and infrared radiation, and/or maintain the wafers at the desired preheat temperature Tₕ. The desired preheat temperature may be selected to allow for some cooling of the semiconductor wafers during transfer from the preheat unit 112 to the etch bath 120 and may, in such instances, be equal to or greater than the temperature of the etch bath.

An alternative to the heated rinse bath of FIG. 4 is illustrated in FIG. 6. As shown in FIG. 6, the rinse bath includes connections through control valves to both a cool water supply and a hot water supply. Using such a configuration, the rinse bath 110 and preheat unit 112 shown in FIG. 3B can be accommodated in a single vessel. The water supply valves may be configured initially to provide only cool rinse water to remove residual BHF solution and maintain the wafers at an initial temperature Tᵢ until such time as the etch bath 120 is, or will shortly be, available. The water supply valves may then be reconfigured to terminate or reduce the supply of cool water to the rinse bath and initiate the supply of hot water. The supply of hot water is then maintained for a time sufficient to preheat, and if necessary, hold until the etch bath is available, the wafers to the desired temperature Tₕ.

In order to demonstrate the utility of the present invention, a conventional wet nitride etch wet station was configured so that it could be operated in both the conventional manner or in a manner according to an exemplary embodiment of the present invention. Using substantially identical wafer carriers and wafer loads, the etch bath, maintained at a target process temperature Tₚ of 163° C., was charged twice, once with wafers directly from the conventional cool water rinse tank and once with wafers from a preheat stage according to the invention.

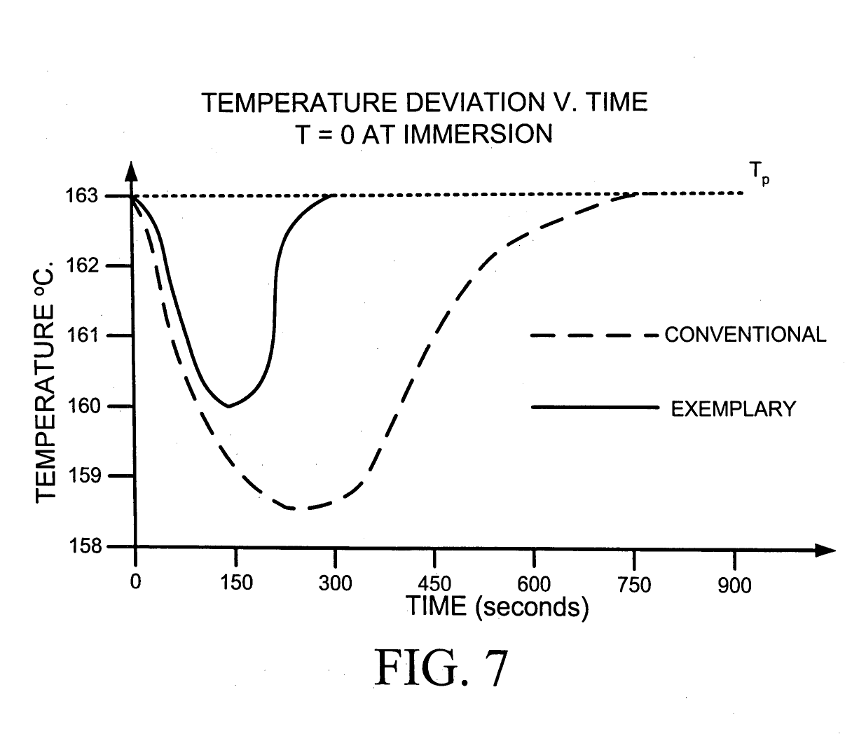

As illustrated in FIG. 7 (dashed line), the etchant temperature immediately began to decrease and continued decreasing for approximately 5 minutes, reaching a minimum temperature of about 158.6° C., only recovering to Tₚ after about 13 minutes. Conversely, as illustrated in FIG. 7 (solid line), when the wafers were preheated according to the exemplary embodiments of the present invention, the etchant temperature decreased to only 160° C. and had recovered to Tₚ after only about 5 minutes. By operating according to the exemplary embodiment of the present invention, therefore, the etchant temperature had returned to Tₚ at about the same time the etchant bath operated according to the conventional method was reaching its minimum temperature and more than about 8 minutes before the conventional process was able to return the etchant bath to Tₚ. This improvement in the temperature control of the hot etchant will translate into improved repeatability of the etch process.

While the present invention has been particularly shown and described with reference to exemplary embodiments thereof, it will be understood by those of ordinary skill in the art that various changes in form and details may be made therein without departing from the spirit and scope of the invention as defined by the appended claims and their equivalents.

What is claimed is:

1. A method of processing semiconductor wafers in a hot process solution comprising:
preheating the semiconductor wafers having an initial wafer temperature Tᵢ to produce preheated semiconductor wafers having a preheat temperature Tₕ; and
immersing the preheated semiconductor wafers in the hot process solution, the hot process solution being maintained at a target process temperature Tₚ, wherein the preheat temperature Tₕ is sufficiently close to the target process temperature Tₚ to prevent significant departure of the temperature of the hot process solution from the target process temperature Tₚ resulting from immersion of the preheated semiconductor wafers.

2. A method of processing semiconductor wafers in a hot process solution according to claim 1, wherein:
the initial wafer temperature Tᵢ is within a range from about 20 to about 30° C.;
the preheat temperature th is within a range from about 70 to 180° C.; and
the target process temperature Tₚ is within a range from about 150 to 180° C:

3. A method of processing semiconductor wafers in a hot process solution according to claim 1, wherein:
preheating the semiconductor wafers includes at least one technique selected from a group consisting of
exposing the semiconductor wafers to a heated liquid,
exposing the semiconductor wafers to a heated gas,
exposing the semiconductor wafers to infrared radiation, and
exposing the semiconductor wafers to microwave radiation.

4. A method of processing semiconductor wafers in a hot process solution according to claim 3, wherein:
exposing the semiconductor wafers to a heated liquid includes at least one technique selected from a group consisting of
immersing the semiconductor wafers in heated water bath, and
spraying the semiconductor wafers with heated water.

5. A method of processing semiconductor wafers in a hot process solution according to claim 3, wherein:
exposing the semiconductor wafers to a heated gas includes at least one technique selected from a group consisting of
exposing the semiconductor wafers to heated N₂ gas,
exposing the semiconductor wafers to heated air, and
exposing the semiconductor wafers to steam.

6. A method of processing semiconductor wafers in a hot process solution according to claim 3, wherein:
immersing the preheated semiconductor wafers in the hot process solution results in a departure from the target process temperature Tₚ of no more than about 3° C.

7. A method of processing semiconductor wafers in a hot process solution according to claim 6, wherein:
immersing the preheated semiconductor wafers in the hot process solution results in a departure from the target process temperature Tₚ lasting no more than about 5 minutes.

8. A method of processing semiconductor wafers in a hot process solution according to claim 1, further comprising:
processing the semiconductor wafers in a first process solution; and
rinsing the semiconductor wafers with water having a water temperature approximately equal to Tᵢ to remove substantially all of the first process solution from the semiconductor wafer before preheating the semiconductor wafers.

9. A method of processing semiconductor wafers in a hot process solution according to claim 8, wherein:
the first process solution is a buffered HF solution having a process temperature of no more than about 30° C.;
the hot process solution is a phosphoric acid solution; and
the target process temperature Tₚ is within a range from about 158° C. to about 168° C.

10. A method of removing a silicon nitride layer from a semiconductor wafer comprising:
preheating the semiconductor wafer to a temperature of at least 70° C. to produce a preheated semiconductor wafer;
immersing the preheated semiconductor wafer in a phosphoric acid solution maintained at a nominal process temperature of at least 150° C. for an etch period sufficient to remove the silicon nitride layer and produce an etched semiconductor wafer;
removing the etched semiconductor wafer from the phosphoric acid solution; and
rinsing the etched semiconductor wafer with water to remove substantially all of the phosphoric acid solution.

11. A method of removing a silicon nitride layer from a semiconductor wafer according to claim 10, further comprising:
immersing the semiconductor wafer in a buffered HF solution; and
rinsing the semiconductor wafer in water before preheating the semiconductor wafer.

12. A method of removing a silicon nitride layer from a semiconductor wafer according to claim 11, wherein:
rinsing the semiconductor wafer includes
flowing water having a temperature of between about 20° C. and about 30° C. past the semiconductor wafer for a rinse period sufficient to remove substantially all of the buffered HF solution from the wafer; and
preheating the semiconductor wafer includes
flowing water having a temperature of between about 70° C. and about 90° C. past the semiconductor wafer for a preheat period sufficient to raise the temperature of the semiconductor wafer to at least about 70° C. to produce the preheated semiconductor wafer.

13. A method of removing a silicon nitride layer from a semiconductor wafer according to claim 12, wherein:
rinsing and preheating the semiconductor wafer are completed in a single vessel, the vessel being arranged and configured for the selective introduction of both cool water and hot water into the vessel.

14. A method of removing a silicon nitride layer from a semiconductor wafer according to claim 11, wherein:
rinsing the semiconductor wafer includes
flowing water having a temperature of between about 20° C. and about 30° C. past the semiconductor wafer for a rinse period sufficient to remove substantially all of the buffered HF solution from the wafer; and
preheating the semiconductor wafer includes
exposing the semiconductor wafer to a hot fluid having a temperature of at least 100° C. for a preheat period sufficient to raise the temperature of the semiconductor wafer to at least about 90° C. to produce the preheated semiconductor wafer.

15. A method of removing a silicon nitride layer from a semiconductor wafer according to claim 14, wherein:
the hot fluid is at least one hot gas selected from a group consisting of heated N₂, heated air and steam.

16. A method of removing a silicon nitride layer from a semiconductor wafer according to claim 10, wherein:
preheating the semiconductor wafer includes at least one method selected from a group consisting of
flowing water having a temperature of at least about 70° C. past the semiconductor wafer for a preheat period sufficient to raise the temperature of the semiconductor wafer to at least about 70° C. to produce the preheated semiconductor wafer,
exposing the semiconductor wafer to a hot fluid having a temperature of at least 70° C. for a preheat period sufficient to raise the temperature of the semiconductor wafer to at least about 70° C. to produce the preheated semiconductor wafer;
exposing the semiconductor wafer to infrared radiation of sufficient intensity and duration to raise the temperature of the semiconductor wafer to at least about 70° C. to produce the preheated semiconductor wafer; and
exposing the semiconductor wafer to microwave radiation of sufficient intensity and duration to raise the temperature of the semiconductor wafer to at least about 70° C. to produce the preheated semiconductor wafer.

17. A method of removing a silicon nitride layer from a semiconductor wafer according to claim 16, wherein:
the preheated semiconductor wafer has a temperature no more than 50° C. less than the nominal process temperature of the phosphoric acid solution.

18. A method of removing a silicon nitride layer from a semiconductor wafer according to claim 17, wherein:
the preheated semiconductor wafer has a temperature no more than 20° C. less than the nominal process temperature of the phosphoric acid solution.

19. An apparatus for processing semiconductor wafers in a hot process solution comprising:
means for preheating the semiconductor wafers having an initial wafer temperature Tᵢ to produce preheated semiconductor wafers having a preheat temperature Tₕ; and
means for immersing the preheated semiconductor wafers in the hot process solution, the hot process solution being maintained at a target process temperature Tₚ, wherein the preheat temperature Tₕ is sufficiently close to the target process temperature Tₚ to limit the departure of the temperature of the hot process solution from the target process temperature Tₚ to no more than about 3° C. and a duration of no more than about 5 minutes.

20. An apparatus for processing semiconductor wafers in a hot process solution according to claim 19, wherein:
the initial wafer temperature Tᵢ is within a range from about 20 to 30° C.;
the preheat temperature Tₕ is within a range from about 70 to 180° C.; and
the target process temperature Tₚ is within a range from about 150to 180° C.

21. An apparatus for processing semiconductor wafers in a hot process solution according to claim 19, wherein:
means for preheating the semiconductor wafers includes at least one assembly selected from a group consisting of
a device arranged and configured to hold the semiconductor wafers in a vessel and to provide the selective introduction of a heated liquid into the vessel,
a device arranged and configured to hold the semiconductor wafers in a vessel and to provide the selective introduction of a heated gas stream into the vessel,
a device arranged and configured to hold the semiconductor wafers in a vessel and to provide the selective introduction of infrared radiation into the vessel, and
a device arranged and configured to hold the semiconductor wafers in a vessel and to provide the selective introduction of microwave radiation into the vessel.

22. An apparatus for processing semiconductor wafers in a hot process solution according to claim 21, wherein:
the device arranged and configured to hold the semiconductor wafers in a vessel and to provide the selective introduction of a heated liquid into the vessel includes
a rinse tank configured to hold the semiconductor wafers,
a hot water supply connected to the rinse tank and
a hot water supply valve selectively operable to control the introduction of hot water into the rinse tank.

23. An apparatus for processing semiconductor wafers in a hot process solution according to claim 22, wherein:
the rinse tank is configured as a quick dump rinser (QDR) and
the hot water supply is configured to deliver deionized water to the rinse tank at a water temperature of at least about 70° C.

24. An apparatus for processing semiconductor wafers in a hot process solution according to claim 21, wherein:
a device arranged and configured to hold the semiconductor wafers in a vessel and to provide the selective introduction of a heated gas stream into the vessel,
a preheating vessel arranged to hold the semiconductor wafers,
a hot gas supply connected to the preheating vessel and
a hot gas supply valve selectively operable to control the introduction of hot gas into the preheating vessel.
